(19) United States
(12) Patent Application Publication
(10) Pub. No.: US 2007/0091431 A1
(43) Pub. Date: Apr. 26, 2007

(54) Rear projection screen, and rear projection system using the screen

(76) Inventors: Samir Mezouari, Swindon (GB); Anna Taylor O'Neil, Buckinghamshire (GB); Yongmin Lee, Oxfordshire (GB); Iman Ibrahim Khandaker, Hertfordshire (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/578,011

(22) PCT Filed: Nov. 5, 2004
(86) PCT No.: PCT/GB04/04709

§ 371 Date: May 3, 2006

(30) Foreign Application Priority Data
Nov. 5, 2003 (GB) 0325849.8

(51) Int. Cl. G03B 21/56

(52) U.S. Cl. 359/449; 359/443

(57) ABSTRACT

A rear projection screen (20) and a rear projection video system using the screen are disclosed. A rear face (20a) of the screen (20) has a structured surface comprising a plurality of light-redirecting elements having transparent planar and/or curved facets (10-13b); each element comprises a facet (10) for transmitting incident light (19), a facet (12) for internally reflecting the transmitted light, at least one facet (11) intermediate and adjoining the facets (10, 12), and a further section (13a, 13b, 52) for separating the facets from those of adjacent elements. Internal angles at the junctions between the first and intermediate, and the intermediate and second, facets (10 & 11, 11 & 12) are at least 90° and no greater than 180°. The front face (20b) of the screen (20) may comprise black stripes (15, 53) and lenticular lenses (14, 40a, 59) to enhance the contrast of the screen. Improved tolerances in manufacturing of the tooling for the screen (20) and against minor component misalignments during system assembly are hereby provided, as are improvements to the robustness of the screen microstructure.

### FIELD OF THE INVENTION

This invention relates to a rear projection screen for a rear projection display, such as a rear projection television system.

### BACKGROUND OF THE INVENTION

Conventional rear projection systems include an image engine source, optics to enlarge and to direct the image light and a transmission screen that is intended to diffuse the image towards a viewing space.

The depth dimension of rear projection systems is traditionally reduced by a set of mirrors that are designed and confined in a compact way to produce a relatively large, contiguous image in a relatively small cabinet. Diverse configurations have been disclosed that make use with some efficiency of the space within the rear projection cabinet. U.S. Pat. No. 3,947,104 discloses a compact imaging apparatus which projects an image upwards using a series of two folding mirrors. U.S. Pat. No. 6,388,810 discloses a rear projection mirror arrangement that includes a curved shape mirror to produce a compact cabinet.

Films incorporating prismatic structures have been used for enabling slimmer optical devices for many years. U.S. Pat. No. 4,984,144 discloses a lighting panel employing a film consisting of linear prisms which are isosceles triangles in cross-section with internal apex angles in the range of 59° to 79°, the film being used to redirect light incident upon it from a near-grazing angle to a direction substantially normal to the exit face.

More recently, the Fresnel lens is becoming commonly used as part of the screen system for the collection of light and the enhancement of the overall display luminance uniformity. However the reduction of the intensity of viewed images due to moiré patterns and ghost images which tend to result from the use of the Fresnel lens are important issues: such artifacts can represent a serious limitation, as reported in U.S. Pat. No. 6,249,376.

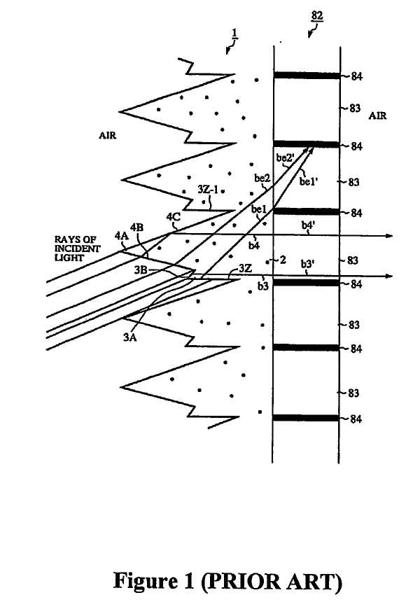

US-A1-2003/0058532, U.S. Pat. No. 6,726,859 B2 and EP-A1-1,324,113 disclose a Fresnel lens that has a structured surface, including a hybrid prism element which comprises a refraction prism unit and a total internal reflection prism unit. FIG. 1 shows one such prior art arrangement. The width ratio of the refraction and the total internal reflection parts of the composite refraction/reflection element is changed gradually in accordance with the variation in the incidence angle across the film: such a structure is evidently complex to manufacture. Furthermore, any gain in intensity uniformity of the display is at the cost of optical efficiency, due to the locally substantial off-normal angle of incidence of the light entering the composite reflection/refraction element. The structure shown in FIG. 1 does not allow placement of the light source so as to produce a large angle of incidence for the light with respect to a normal to the relatively planar, macroscopic surface of the screen. This is because a large angle of incidence would mean that some parts of the structure would not be illuminated as they would be in the shadow caused by other parts of the microstructure. This prevents realization of a very slim profile TV system.

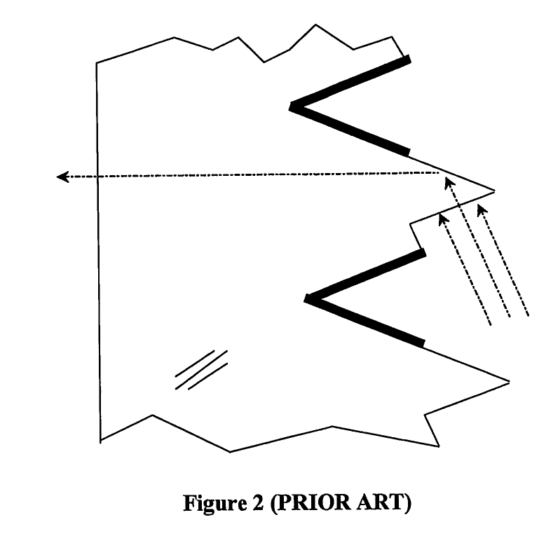

U.S. Pat. No. 6,597,417 B1 and US-A1-2002/0186465 disclose another prior art arrangement, of which FIG. 2 is an example. This figure shows a design which redirects the light incident at an oblique angle by total internal reflection, with the aim of improving optical efficiency and contrast. However, such structures require a relatively small prismatic apex angle, which implies a need for tighter tolerances in manufacture and alignment.

A similar prismatic structure is disclosed in U.S. Pat. No. 6,608,961 B2. Other prior art includes a prismatic structure of varying pitch and height for a similar purpose, described in U.S. Pat. No. 4,512,631. However, the application described therein is operation for light incident normal to the screen.

It would be desirable to provide a rear projection screen, and in particular a rear projection screen for slim television applications, which may achieve high transmission efficiency, high contrast, improved robustness, ease of manufacture and/or enhanced optical alignment tolerance.

The present invention aims to address the above and other objectives by providing an improved optical panel for use as a rear projection screen.

### SUMMARY OF THE INVENTION

According to one aspect of the present invention, there is provided an optical panel comprising an optical film for redirecting light incident upon a rear face of the optical film, the optical film comprising: a front face; and a rear face having a plurality of substantially periodic light-deflecting elements disposed thereon, each respective element comprising: a transparent first facet for transmitting light incident thereupon; an internally reflecting second facet for effecting internal reflection of the transmitted light within the element; at least one intermediate facet disposed between and adjoining the first and second facets at first and second junctions respectively; and a further section disposed between the second facet of the element and a first facet of an adjacent element, wherein a first and a second full internal angle within the element at the first junction and the second junction respectively is at least 90 degrees and no greater than 180 degrees.

The depth of a rear projection cabinet can be strongly influenced by the angle of incidence of the light incident on the rear face of the screen. To reduce the depth of the rear projection cabinet, the image light engine can be placed to the side of and close to the screen so that the angle of incidence may be increased to above 45°. The incident rays can be nearly parallel to the (macroscopically) relatively planar surface of the rear face of the screen in some embodiments of the invention.

Advantageously, the rear projection screen may achieve high transmission efficiency whilst optionally providing high contrast across the screen for the obliquely incident light beam. The back face of the screen comprises a prismatic structure which may incorporate one or more curved facets in the prismatic unit which is repeated across the screen. If employed, the one or more curved facet of a lenticular prism acts as a light concentrator to focus light in order to enhance the contrast of a displayed image.

The front face of the screen may include an array of lenticular lens elements combined with black stripes to absorb the ambient light. Alternatively, or additionally, the rear face of the screen may include a plurality of black stripes. In either case, the black stripes are arranged so as not to interfere with the path(s) taken by the light through the screen. In operation, the image light received from an image engine is transmitted by one facet of the prism and undergoes internal reflection, which is preferably total internal reflection (TIR), by one or more facets of the prism so the light is redirected and diffused towards the viewing space. Although for optical efficiency internal reflection of the transmitted light is preferably achieved by TIR, specular reflection may alternatively be employed.

The rear projection screen may be illuminated by an image engine source, the light being incident on the screen at an angle of incidence of at least =b 45 degrees. The screen microstructure is such that it facilitates the manufacturing of the tooling required for mass production, and is capable of accommodating minor misalignment of the screen during TV system assembly.

The intermediate facet preferably comprises just one facet, but may alternatively include two or more facets or sections disposed between the first and second facets. The at least one intermediate facet may be arranged in use to be substantially parallel to a direction of the light incident upon the first facet. Alternatively, in use, the at least one intermediate facet may be substantially parallel to any direction lying in a range between a direction of the light incident upon the first facet and a direction of the light transmitted by a region of the first facet closest to the first junction with the intermediate facet.

Preferably, the further section of the element does not have a transmissive or reflective optical function, although it may be arranged to perform such a function or functions depending on the requirements of a particular application.

According to a further aspect of the present invention, there is provided an optical panel for displaying projected light incident upon the optical panel, the optical panel comprising a front face and a rear face, the rear face having a plurality of substantially periodic light-deflecting elements disposed thereon, each respective element comprising: a transparent first facet for transmitting light incident thereupon; an internally reflecting second facet for effecting internal reflection of the transmitted light within the element, the second facet being adjoined to the first facet; and a further section disposed between the second facet of the element and a first facet of an adjacent element, wherein at least one of the first and second facets of the element is convexly curved so that a function of the first and second facets acting in concert includes bringing the transmitted and reflected light to a focus at or near to a plane defined by the front face of the panel.

The front face of the screen may include an array of lenticular lens elements combined with black stripes to absorb the ambient light. Alternatively, or additionally, the rear face of the screen may include a plurality of black stripes. In either case, the black stripes are arranged so as not to interfere with the path(s) taken by the light through the screen.

According to a further aspect of the present invention, there is provided a rear projection video system, comprising: the optical panel of any embodiment of the invention; and a rear projector arranged to project a video image onto the rear face of the optical panel for providing a viewable image downstream of the front face of the optical panel.

According to a further aspect of the present invention, there is provided an optical film for an optical panel, the optical film being in accordance with any embodiment of the invention.

According to a further aspect of the invention, there is provided an optical panel, for use, for example in rear projection video systems, the panel comprising a transparent body having a rear surface characterised by a plurality of ribs and grooves, each said rib including a transparent face on one side of the rib and an internally reflective face on the opposite side of the rib, such that light, for example from a projection system, directed obliquely with respect to the panel so as to pass through said transparent face towards the adjoining internally reflective face will be reflected by the latter face to pass through said transparent body towards the front surface of said panel.

According to a further aspect of the invention, there is provided an optical panel for displaying projected light formed by a primary source arranged behind the optical panel, wherein the said optical panel comprises: a back face having a (transparent,) substantially periodic structure comprising a series of groups of faces or sections; each said group comprising: a transparent first section or face for transmitting the said light, (a transparent second section or face adjoining said first section and substantially parallel to said light,) and a (transparent) third section or face (adjoining said second section) for effecting total internal reflection of said transmitted light, (said second section being situated between said first section and said third section, and a fourth section adjoining said third section to the adjacent said first section).

According to a further aspect of the invention, there is provided an optical panel for displaying a projected light formed by a primary source arranged behind the optical panel, which optical panel comprising: a back face having a transparent substantially periodic structure constituted by a group of transparent facets; a transparent first section for transmitting the said light, and a transparent second section adjoining said first section for effecting total internal reflection of said transmitted light (situated between said first section and said second section), and a third section adjoining said second section to the adjacent said first section.

Preferably, the first section is a focusing element. Advantageously, the first section is a focusing element comprising at least one curved facet. Preferably, the first section is a focusing element comprising a plurality of facets. Alternatively, the first section is a planar facet.

Preferably, the length of the second section controls the thickness of said optical panel. Alternatively, the focusing power of the first section controls the thickness of the optical panel.

Advantageously, the third section is a folding and focusing element. Advantageously, the third section is a folding and focusing element comprising at least one curved element. Preferably, the third section is a folding and focusing element comprising a plurality of facets. Alternatively, the third section is a folding planar facet.

Advantageously, the third section is coated to enhance the total internal reflection effect.

Preferably, the fourth section is a single or a plurality of transparent facets. Alternatively, the fourth section is a single or a plurality of absorbing facets.

Advantageously, the optical panel comprises a front face opposite to the back face, the front face comprising: black barriers for absorbing light, and transparent intervals between the black barriers for transmitting the redirected light reflected by the third section.

Preferably, the optical panel includes an additional element or elements between the periodic structures to produce a non-periodic structure.

Preferably, the first section is a planar facet and the second section is a focusing element.

Preferably, the focusing power of the first section controls the thickness of the optical panel.

Advantageously, the second section is a folding and focusing element. Preferably, the second section is a folding and focusing element comprising at least one curved element. Alternatively, the second section is a folding and focusing element comprising a plurality of facets. Alternatively still, the second section is a folding planar facet.

Preferably, the second section is coated to enhance the total internal reflection effect.

Advantageously, the third section is a single or a plurality of transparent facets. Alternatively, the third section is a single or a plurality of absorbing facets.

Advantageously, the optical panel comprises a front face opposite to the back face comprising: black barriers for absorbing light, and transparent intervals between the black barriers for transmitting the redirected light reflected by the second section. Preferably, the black barrier comprises paint. Preferably, the black barrier comprises black coating.

Preferably, the transparent intervals comprise an array of cylindrical lenses. Preferably, the cylindrical lenses are arranged to increase the horizontal angle of view.

According to a further aspect of the invention, there is provided a rear projection video system incorporating an optical panel in accordance with the invention. Preferably, the rear projection video system further comprises at least one light generation system. Advantageously, the light generation system includes: a single light source or a plurality of light sources; and a Digital Processing unit for reduction of keystone-type distortion of the image. Alternatively, the light generation system includes: a single light source or a plurality of light sources; and an anamorphic optical element for reducing keystone-type distortion of the image. Alternatively still, the light generation system includes: a single light source or a plurality of light sources; and a hybrid optical/digital element or elements for reduction of keystone-type distortion of the image.

Advantageously, the light generation system includes a light source for producing the light, and a modulator for modulating the light to form an image. Preferably, the light sources comprises a source selected from the group consisting of Liquid Crystal Display (LCD), a Digital Micromirror Device (DMD), a laser-raster scanner, a Microelectromechanical System (MEMS), a Cathode Ray Tube (CRT), Light Emitting Diode (LED), Organic Light Emitting Diode (OLED), or Grating Light Valve (GLV).

Preferably, the light generation system includes image optics for distributing the light horizontally and vertically. Advantageously, the image optics include focusing lenses and mirrors. Alternatively, the image optics comprise expansion optics.

Advantageously, there is a multiplicity of light generation systems to provide light, preferably up to, and including, four systems.

Preferably, the rear projection video system comprises a cuboid housing enclosing said light generation system, associated imaging optics, associated electronics and said optical panel as front face for displaying the image. Advantageously, the first section of the optical panel is a planar facet and substantially perpendicular to the incident rays of light.

Other preferred features are set out in the description, and in the dependent claims which are appended hereto.

The present invention may be put into practice in a number of ways and some embodiments will now be described, by way of non-limiting example only, with reference to the following figures, in which:

FIG. 1 shows a prior art arrangement of a prismatic structure for a hybrid Fresnel lens screen;

FIG. 2 shows a prior art arrangement of a prismatic structure with black material on the structure, for contrast enhancement, and having a notch for improving optical efficiency;

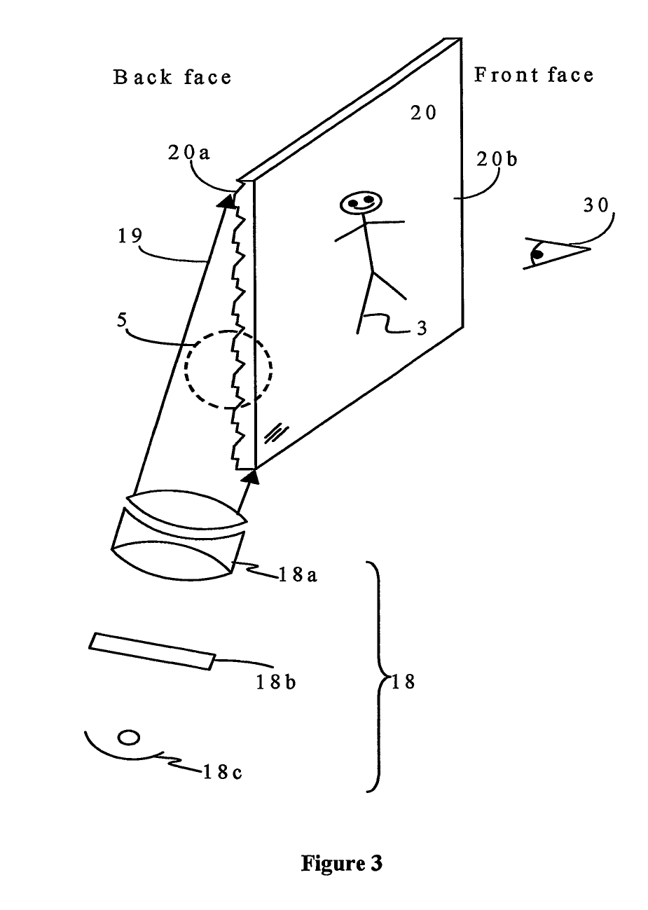

FIG. 3 is a schematic view illustrating a rear projection system in accordance with the invention;

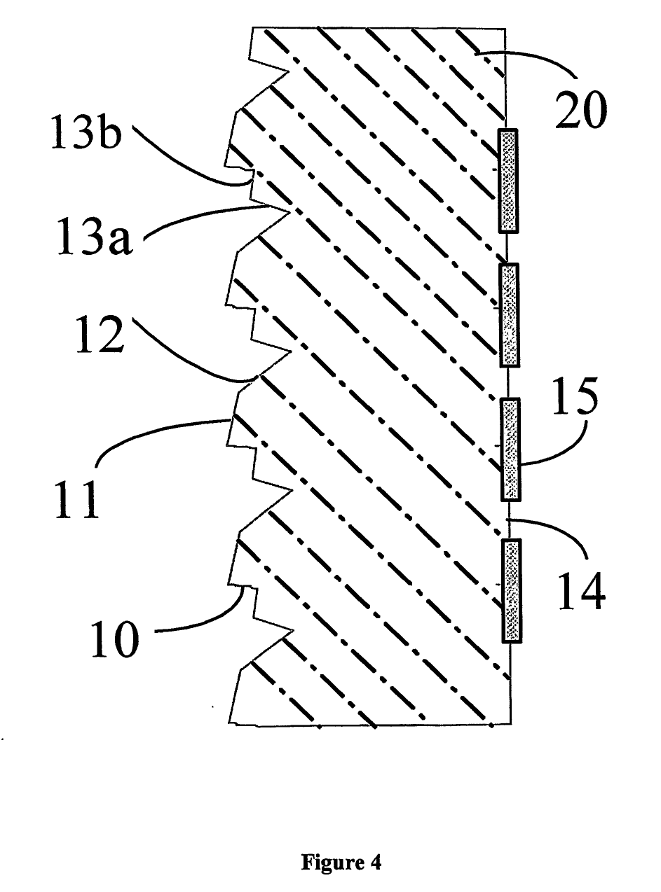

FIG. 4 is a cross-sectional view, of an enlarged scale, through the optical panel or screen of the system shown in FIG. 3;

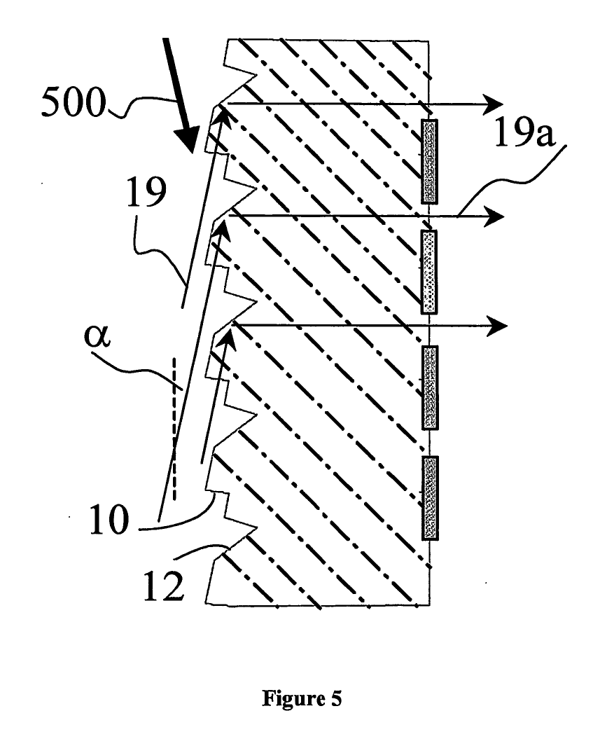

FIG. 5 is a view corresponding to FIG. 4, but illustrating the redirection of light beams by total internal reflection;

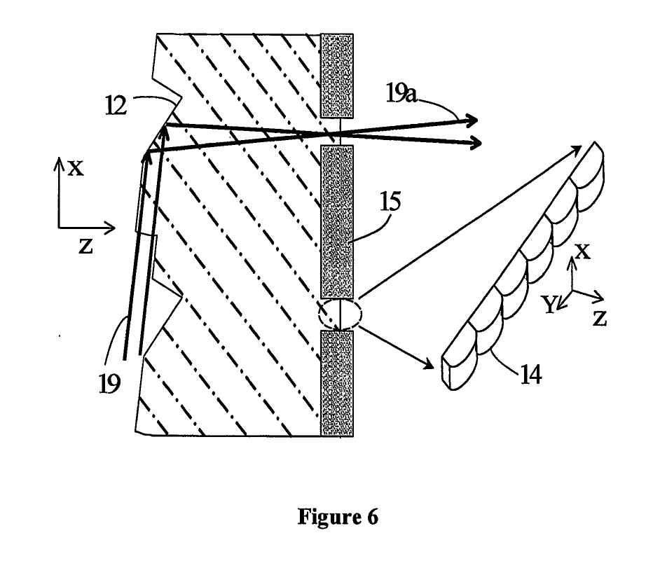

FIG. 6 is an enlarged cross-sectional view of an embodiment of the rear projection screen which includes cylindrical lens elements. The figure illustrates the redirection and focusing effect on the image light beam according to this embodiment;

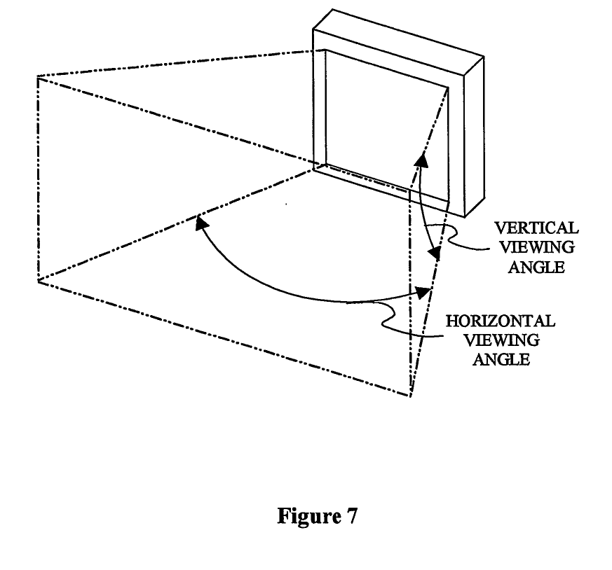

FIG. 7 is a schematic view showing the horizontal and the vertical viewing angles of the screen;

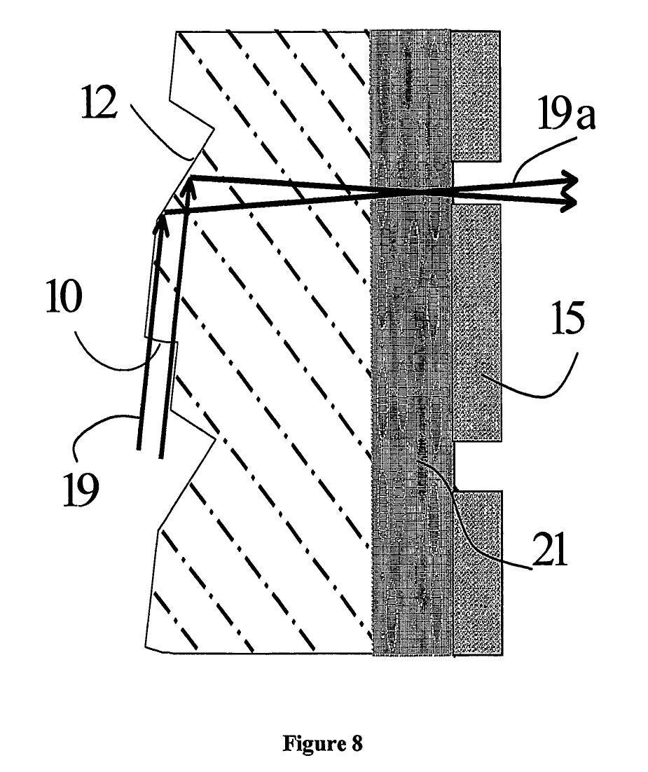

FIG. 8 is a cross-sectional view of an embodiment of the screen, illustrating the redirection and the diffusion of the image light beam using a diffuser instead of cylindrical lens elements;

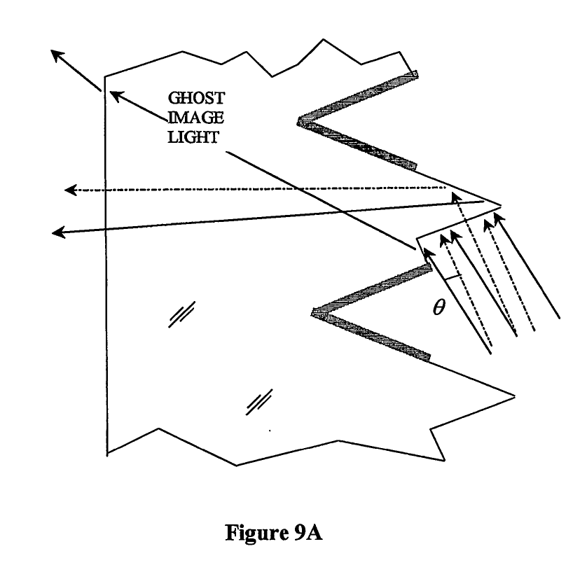

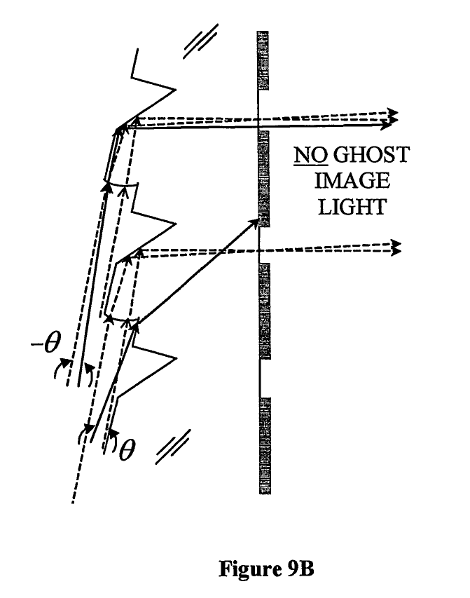

FIG. 9A shows the presence of ghost image light being transmitted to a viewer with a prior art arrangement;

FIG. 9B shows an embodiment of the invention which can absorb ghost image light so it is not present for the viewer;

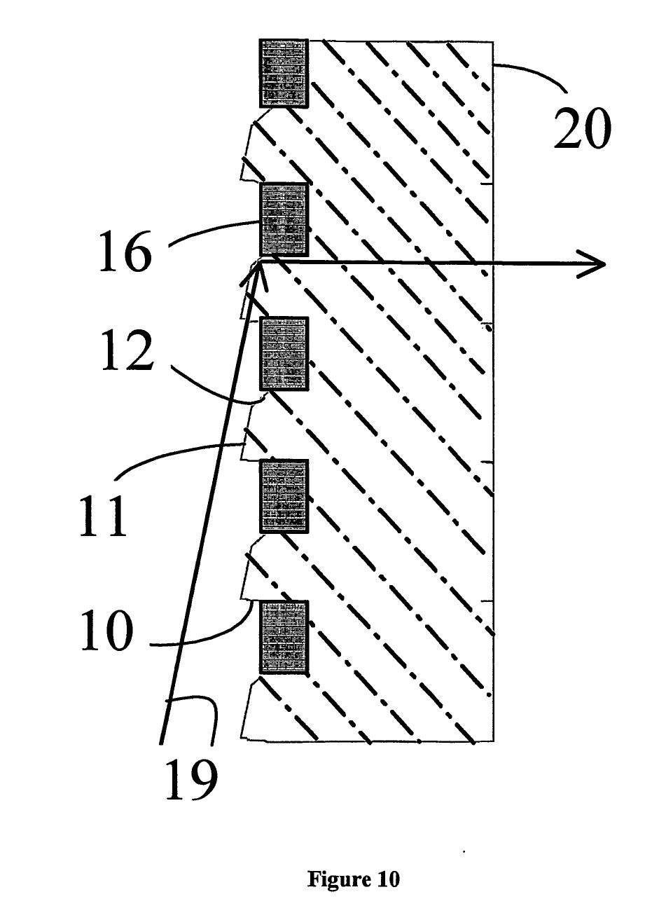

FIG. 10 is a view similar to FIG. 5 but illustrating an embodiment incorporating black stripes for contrast enhancement at the back face of the screen;

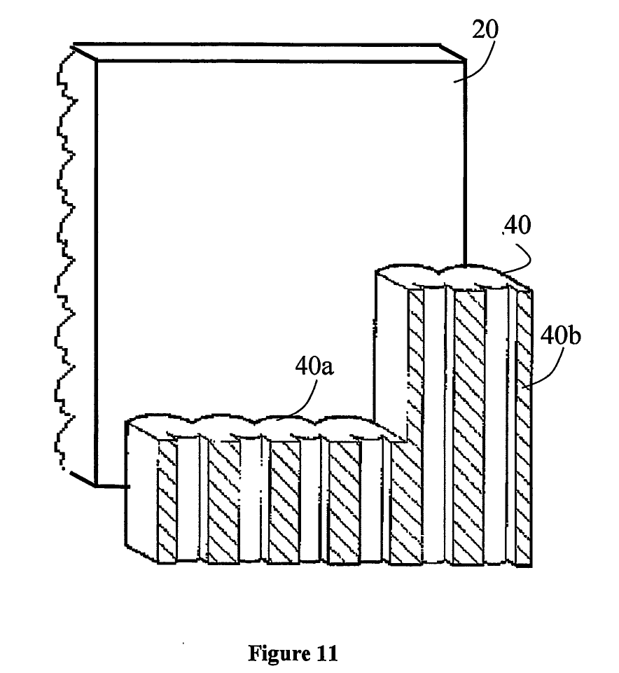

FIG. 11 shows an optical panel according to another embodiment that combines the lenticular lens sheet to make up the whole screen;

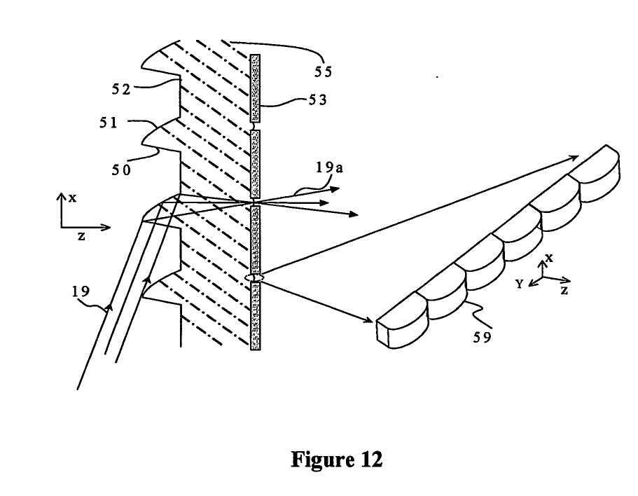

FIG. 12 shows a further embodiment illustrating the focusing and the redirection of an image light beam by total internal reflection, similar to FIG. 6;

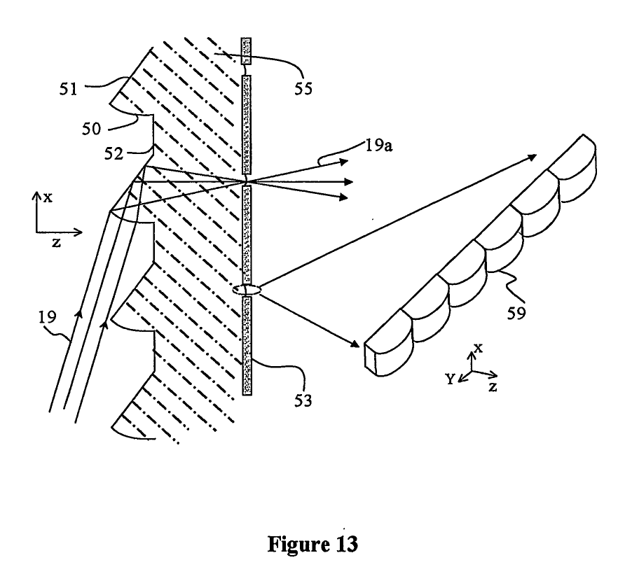

FIG. 13 shows a further embodiment illustrating the focusing and the redirection of an image light beam by total internal reflection, similar to FIG. 6;

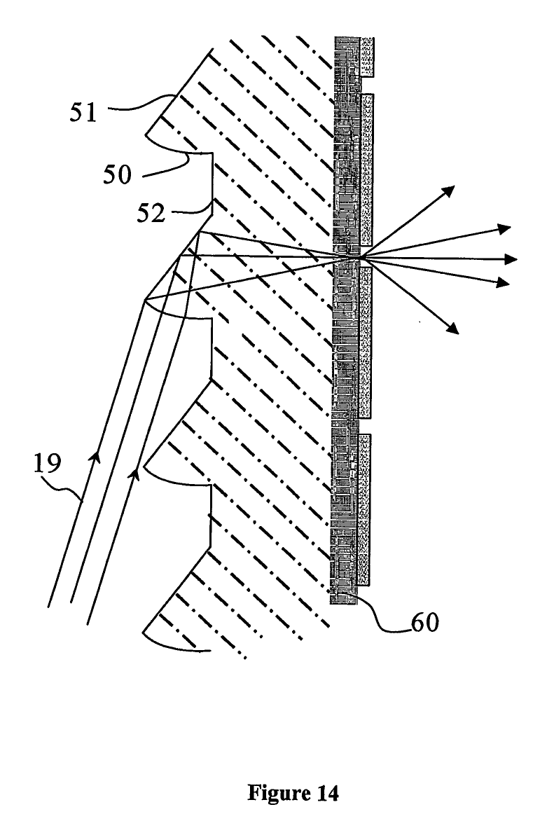

FIG. 14 shows a further embodiment, similar to FIG. 8, illustrating the redirection and diffusion of the image light beam using a diffuser, but with a different structure on the back face; and

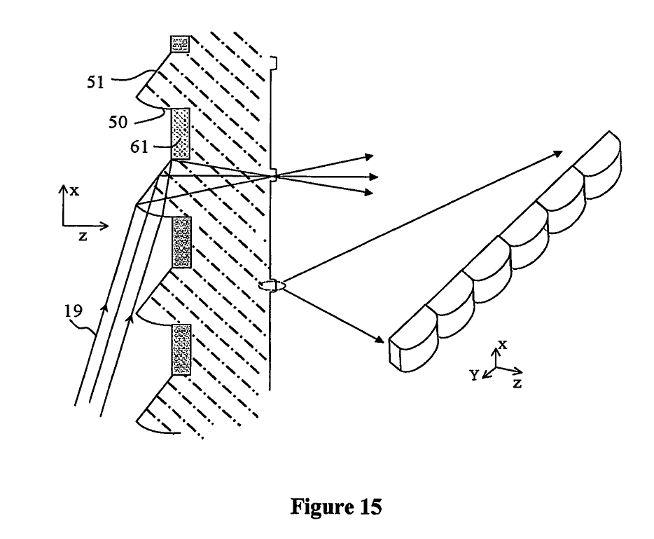

FIG. 15 shows a further embodiment illustrating the focusing and the redirection of an image light beam by total internal reflection, similar to FIG. 6.

### DETAILED DESCRIPTION OF THE INVENTION

Referring to FIG. 3, there is shown a schematic view illustrating an optical panel. 20 in a rear projection video system in accordance with an exemplary embodiment of the invention.

The system may be housed in a slim, compact, cabinet with the optical panel 20: the housing will include all working components. In the embodiment shown in FIG. 3, the optical panel 20 is placed in combination with a projector 18 suitably designed for projecting a video image 3 onto the optical panel for direct viewing by an observer 30 facing the optical panel.

The system allows the dimensions of the panel 20 to be scaled for any desired application, from a large screen suitable for viewing by the crowd at a sports stadium to a small screen suitable for a portable display such as one on a mobile phone.

In the arrangement shown, the projector 18 comprises a light source 18c, a light modulator 18b, and imaging optics 18a which direct light, from light source 18c, after modulation by modulator 18b, onto the back face 20a of the optical panel 20. The projector 18 described may consist of any conventional form capable of projecting an image 3. The image light 19 can either be of collimated or diverging nature, however, the curvature of the facets on the back face 20a of the optical panel 20 are preferably such as to, as a minimum, collimate or else focus any diverging light beam incident thereupon.

The light source 18c may be a light bulb, slide projector, video projector, or laser. In some embodiments a light modulator 18b may be included in the projector 18: this can modulate the image light 19 to form an image 3. There are many types of modulator 18b that can be included in different embodiments of the final slim rear projection television. For example, separate embodiments could encompass, but are not limited to any or a combination of the following: a conventional Liquid Crystal Display (LCD), a Digital Micromirror Device (DMD), a laser-raster scanner, a Microelectromechanical System (MEMS) technology system, a cathode ray tube (CRT), or a single or an array of Light Emitting Diodes (LED), Organic Light Emitting Diodes (OLED), or Grating Light Valves (GLV).

The projector 18, is used as a means for producing an image 3 which is directed obliquely on to the back face 20a of the optical panel 20. This projector 18, may also include suitable imaging optics 18a for distributing the image light 19 horizontally and vertically over the back face of the optical panel 20a for transmission therethrough. The imaging optics 18a, which may include folding mirrors and lenses, are optically aligned between the back face of the optical panel 20a and the light modulator 18b. The optical system may include a Digital Signal Processing unit for reduction of keystone-type distortion of the image, or an anamorphic optical element for reducing keystone-type distortion of the image, or a hybrid optical/digital element or elements for reduction of keystone-type distortion of the image.

FIGS. 4 and 5 illustrate an enlarged portion 5 of the optical panel 20 shown in FIG. 3.

The optical panel 20 may comprise a unitary panel having a rear surface provided by a plurality of parallel ribs and grooves, the longitudinal extent of which runs generally perpendicular to the direction of the light rays 19 passing to the rear surface of the panel from the image projection means. The ribs and grooves, defining a series of light-deflecting elements, which are preferably (but depending on application, not necessarily) of constant cross-section throughout their length.

In this embodiment, on a relatively large scale (macroscopically), the rear surface 20a of the optical panel 20 may be considered to be generally planar; however, on a relatively smaller scale (microscopically), the rear surface has a waveform or a substantially periodically varying profile. That layer of the optical panel 20 which includes the ribs and grooves is referred to as an optical film. Indeed, while it is preferable for the optical film to be integral with the rest of the panel 20, it may alternatively be manufactured and provided separately, then fixed or bonded to the panel.

In detail, each respective element of the optical film shown in the embodiments of FIGS. 4 and 5 includes, extending from the rearmost limit of facet 10, a facet or section 11 which is optically non-functional and extends generally perpendicularly to facet 10 and thus parallel with light rays 19. The facet 11 extends to an internally reflective facet or section 12, which slopes from the facet 11 towards the front surface of the panel 20 and terminates in the bottom of a groove. The opposite wall of the groove is formed by an optically non-functional facet or section 13a extending rearwardly to yet a further facet or section 13b. The facet 13b extends generally parallel with the front surface of the panel 20, to an edge of the next/adjacent rib/groove element, which starts with a further facet 10.

A light ray 19 passes into the panel 20 through a facet 10 of an element and is reflected internally within the element, at the facet 12. The ray 19 then passes approximately perpendicularly to the planes of major extent of the panel (that is, the planes defined by the macroscopic front and rear faces) and exits through the front surface for viewing by an observer downstream of the panel.

The material that forms the optical panel 20 can be suitably selected to be transparent in accordance with the application. The rays of image light 19 are incident in a direction substantially perpendicular to the facet 10, which reduces the scope for the occurrence of ghost image light.

The transparent facet 10, which is generally planar in FIGS. 4 and 5, has a curved shape in the preferred embodiment. The curvature of the facet 10 controls the vertical viewing angle of the panel display, as shown in FIG. 7, and concentrates or focuses the transmitted light 19 in the vertical direction. This enables the provision of black stripes 15 over the front face of the optical panel 20 to provide superior contrast. The black stripes 15, whose presence is preferred but is not essential, absorb the ambient light while the reflected image light 19a is transmitted between the black stripes 15. The location of the black stripes 15 at the front face of the optical panel 20, and the large fraction of the area on the front of the screen that can be covered with absorbing material, allows greater improvement of the contrast achievable by this screen. In particular, the absorption of the ambient light by the absorbing material on the front preventing its refraction or reflection within the display system improves the darkness of the off state, i.e. the dark state, of the screen resulting in greater contrast when images are displayed on the screen. The active area of the screen for (total) internal reflection and redirection towards the viewer is well defined and there exist significant tolerances in the incidence angle of light from the light source, thereby preventing ghost images being created and transmitted through the system.

The full internal angles between the physical junctions between facets 10 and 11, and facets 11 and 12, in this microstructure are defined by the geometrical function performed here by the microstructure to be no less than 90° and no greater than 180°.

It will be appreciated by those skilled in the art that in the case where the first facet 10 is convexly curved so as to act as a focusing element, the direction of the second facet 11 is not constrained to be parallel to the direction of the light incident upon the first facet 10, but may take any direction parallel to the directions between the light incident on facet 10 and the light transmitted by the part of facet 10 which is closest to facet 11.

The embodiment of the invention described in FIG. 4 provides a number of advantages. FIG. 2 shows a prior art design which redirects the light incident at an oblique angle by total internal reflection. However, such structures require a relatively small prismatic apex angle, which implies tighter tolerances in film manufacture and in optical alignment during display system assembly. Structures comprising small prismatic apex angles tend not to be very tolerant of wear which occurs to the cutting element during the cutting of the master tool, by which the optical films are manufactured, as the shape of the structure cut into the master tool is relatively sensitive to wear which occurs to the cutting element. Background discussion of tool manufacturing is given in U.S. Pat. No. 5,919,551. Cutting away material from the master tool results in wear to the cutting element, making it difficult to achieve structural uniformity across the master tool. For example, a prismatic unit element structure might be 100 μm across, whereas the master tool might be 1 m across, implying the need to cut off the order of 10,000 such microstructures while maintaining microstructural shape uniformity; for example, with respect to microstructure dimensions, microstructure internal angles, and sharpness of the junction between microstructure facets. In the embodiment shown in FIG. 4, the respective internal angles between the ‘optically operative/functional’ facets, namely facets 10 and 12, and the facet between and adjoining them, lies in the range from 90° to 180°. As such, the optical film structure may benefit from relatively greater tolerance of wear to the master tool's cutting element during manufacture.

A further advantage of the embodiment of the invention described in FIG. 4 is the increased robustness of the film with respect to damage to the microstructure which can lead to optical defects such as bright or dark spots on the screen as perceived by the viewer of the screen. As the internal angles of the microstructure become smaller, the microstructure becomes more delicate and is more susceptible to damage such as during film manufacture as the film is released from the tooling, during optical panel assembly and during the usage lifetime of the optical panel during which the panel can be expected to be subjected to mechanical perturbation, such as during long distance transport or during relocation within a room. The relatively large internal angles of the embodiment of the invention described in FIG. 4 therefore lead to increased robustness of the film with respect to damage to the microstructure, especially with respect to damage to the tips of the microstructure such as those shown in FIG. 2.

Another advantage of the embodiment of the invention described in FIG. 4 is an increased useful production lifetime of the master tooling in film manufacture. For a given cutting element wear profile/rate, the more acute the prismatic internal angles, the more quickly the master tooling microstructure will be altered significantly during manufacture, through for example the rounding-off of the junction between facets. The obtuse internal angles of the optically functional parts of the microstructure disclosed in FIG. 4 will therefore promote the useful production lifetime of its master tooling.

General background discussion is given in Altan, T., Oh, S. I., and Gegel, H. L. (1983), “Metal Forming Fundamentals and Applications”, American Society for Metals, Metals Park, Ohio, USA, and in M. A. Davies et al., “Lithographic and Micromachining Techniques for Optical Component Fabrication II”, Proc. of SPIE, Vol. 5183, pp. 94-108, edited by E.-B. Kley, H. P. Herzig (SPIE, Bellingham, Wash., USA, 2003).

The grazing incidence angle α, which is 90° minus the angle of incidence (i.e. its complement), controls the depth of the cabinet housing of the display system. Unless otherwise specified/defined for a particular case in this specification, the term “angle of incidence” generally refers to the angle formed between a ray of light incident upon the rear face of the panel and a normal to the generally (macroscopically) planar surface of the rear face. In the present embodiment, α has an acute value. Preferably, the grazing incidence angle α has a value substantially between 0° and 45° , more preferably a has a value substantially between 0° and 30°.

In the embodiment shown in FIG. 4, the facet 11 is substantially planar and is substantially parallel to the rays of the incident light 19. The facet 12, which may have a convex shape, such as a conical, elliptical, hyperbolic, or a spherical shape, is preferably planar and forms a suitable angle with facet 11 to reflect the transmitted light 19 towards the observer 30. The surface of the facet 12 may be coated for more efficient internal reflection. Because the index of refraction of the environment medium (e.g., surrounding air) is lower than the index of refraction of optical panel 20, as illustrated in FIG. 5, the facet 12 redirects the image light 19 by total internal reflection, depending upon the specific refractive index and angle of incidence of reflection.

The facets 13a and 13b are planar in the case shown in FIGS. 4 and 5. However, facets 13a and 13b may have a curved or an arbitrary shape, the shape being constrained by the necessity not to block the light from the image light source outside the screen from propagating towards facet 10.

As discussed above, forming small angles between adjacent facets of a light-redirecting element requires relatively high precision in the machine tooling. In the embodiment shown in FIG. 4, the only acute angle is that formed at the junction between facets 12 and 13a. This part of the structure has no optical function, hence there are very wide tolerances as to the angle and the junction shape realized in the manufacturing procedure, including wide tolerance of any surface roughness occurring in this junction region. Such tolerances may lead to significant manufacturing benefits, for example, by reducing rejections of machine tools or the optical films formed from them, and by increasing the working lifetime of the machine tool's cutting element.

The optical film can be produced by a tool manufactured by any known method. If the tool used to produce the film is a roll, it can be manufactured by plunge cutting or by any other useful method. Planar tooling as discussed in U.S. Pat. No. 5,183,597 may also be employed. There are many suitable materials from which the optical film can be made, such as, but not limited to, those described in U.S. Pat. No. 5,175,030.

FIGS. 6 and 8 illustrate a lens focusing effect due to the provision of curved facets. The focusing effect may be generated by facet 10 alone or by facet 12 alone, or by facets 10 and 12 acting in concert. Following reflection at facet 12, the image light is concentrated on, or near to, the front face 20b of optical panel 20. In the embodiments shown, thereafter the light 19a is diffused or distributed in the horizontal direction to increase the viewing angle accordingly, as shown in FIG. 7. In FIG. 6, this is achieved by means of cylindrical lenticular lenses 14 that extend horizontally along those parts of the front face 20b to which light is focused by respective light-deflecting elements. In FIG. 8, this is achieved by using a diffuser layer 21 to enlarge the horizontal viewing angle. For a given facet curvature, such as could be given by facet 10 alone, which leads to a focusing of light at the position between two black stripes 15, increasing the separation between the light-transmitting facet 10 and the light-reflecting facet 12, by increasing the length of facet 11, enables the thickness of the optical panel to be reduced. Such reduction in the thickness of the optical panel 20 allows a considerable reduction of the film material volume, and hence implies a more lightweight structure and lower total materials cost. A reduction in the thickness of the optical panel 20 may also be attained by arranging the curvature of the facet 10 and/or facet 12, such that the light-transmitting, -reflecting and -focusing effects of the two facets bring the light to a focus over a relatively shorter path length from entry into the panel, i.e. by actually reducing the focal length of the light-redirecting element.

Additionally, the focusing elements relax the constraint of alignment between the optical panel 20 and the image light 19. This presents an advantage over the prior art, in which a misalignment of the light source may lead to the production of ghost images, as shown in FIG. 9A. Such undesirable ghost images can be prevented or significantly reduced in intensity by the use of a focusing element at facet 10 or facet 12, as illustrated for example by the curved facet 10 in FIG. 9B.

Since in most embodiments the facets 13a and 13b have no optical function, there exists a wide choice in the shapes and materials which can be employed in this part of the microstructure. An example of a possible embodiment is illustrated in FIG. 10, in which the facets 13a and 13b are substituted by a black stripe 16. Alternatively, the facets 13a and 13b may be coated with a suitable absorbing material or structure. Though the embodiment in FIG. 10 may achieve less contrast than the embodiments shown in FIGS. 6 and 8, the embodiment in FIG. 10 can be less complex to implement practically, because precision alignment between the position of the absorbing material 16 and the direction of the incident or transmitted light 19, 19a is not required.

Facet 11 has no optical function and therefore it can be coated with a thin layer of dark or absorbing material in such a way that the image light 19 is not deflected or absorbed. When facet 11 is coated with absorbing materials, the optical panel 20 achieves higher contrast because the path of stray light is blocked. The procedure of coating facet 11 may be achieved by using standard coating techniques, such as a controlled directional spray coating. FIG. 5 shows an approximate direction of the spray used for such a coating process, indicated by the arrow 500. It will be apparent to those skilled in the art that when spray coating from an appropriate oblique direction, such as indicated by arrow 500 in FIG. 5, facet 10 will remain uncoated, as required by its transmissive function. Although it may be desirable for part of facet 12 to be spray coated with absorbing materials during the process described above, the light 19 should be refracted and/or focused by facet 10 towards the uncoated part of facet 12. In this way, the light 19 can be reflected by total internal reflection at facet 12 without optical losses caused by the coating, which could alter the critical angle for total internal reflection on the coated parts of facet 12. Therefore the coating process can constitute part of the manufacturing advantages disclosed for the present invention.

The following non-limiting example has been simulated and verified using the optical simulation software sold by ZEMAX Development Corporation, San Diego, Calif., USA. An example of the present invention is an optical panel approximately 2 millimetres in thickness with a pitch of 40 micrometres and made of polycarbonate. The radius of curvature of facet 10 is 1.24 millimetre and the full height of the prismatic structure is 16 micrometres. This optical panel is designed to redirect light that is incident with α=12 degrees (and an incident angle of 78°). In this example, facet 11 is parallel to the incident light. Facet 12 and facet 11 form an angle of 141 degrees. Facet 12 is optically flat (planar). The lengths of facet 10 and facet 11 are 16.3 micrometres and 5 micrometres respectively.

In one of the embodiments, the optical panel 20 may be used in combination with various elements of the related art. For example, a lenticular lens sheet 40 that has a lenticular lens 40a for horizontal diffusion is placed in front of the optical panel 20, as illustrated in FIG. 11, to increase the horizontal field of view and enhance the contrast of the screen by including absorbing structure 40b. Alternatively, instead of the lenticular sheet 40, another example is of a stack of alternating waveguides and black layers, such as that described in WO-A1-2004/023176. Alternatively, a stray light absorbing plate 82 comprising a plurality of light transmitting layers 83 which are alternately layered with thin-film light absorbing layers 84, as shown in prior art FIG. 1, may be used.

The embodiments shown in FIGS. 12 and 13 provide an optical panel 55. The optical panel 55 has a plurality of light-redirecting elements disposed on a rear surface. In FIG. 12, each element comprises a transparent planar facet 50, whereas in FIG. 13, facet 50 is convex, such as a conical, elliptical, hyperbolic or a spherical shape. The facet 50 adjoins an internally reflecting facet 51, which is curved in FIG. 12 and planar in FIG. 13. Preferably, at least one of the facets 50, 51 is curved, and in some embodiments, both facets may be cooperatively curved to function in concert as focusing elements. Each element on the rear surface of the optical panel 55 is separated from adjacent elements by a further section 52.

The material that forms the optical display panel 55 can be suitably selected to be transparent according to the application. The rays of image light 19 are substantially perpendicular to the facet 50, which ensures high transmittance and prevents the formation of ghost image light. The curvature of the facet 50 controls the vertical viewing angle of the panel display 55, as shown in FIG. 13, and concentrates the transmitted image light 19 in the vertical direction to pass the light 19a between the black stripes 53 on the front surface of the panel which absorb the ambient light, to provide and to augment the contrast background. The curved facet 51 as shown in FIG. 12, which may also be planar as shown in FIG. 13, reflects the transmitted light 19 towards the observer 30 by total internal reflection. The redirected light 19a is diffused in the horizontal direction to increase the viewing angle accordingly, as shown in FIGS. 12 and 13, by means of cylindrical lenticular lenses 59. FIG. 14 illustrates a further embodiment in which diffuser 60 is used to enlarge the horizontal viewing angle.

The incorporation of facet 52 in the present embodiments shown in FIGS. 12, 13 and 14 allows much easier and cost-effective manufacture of the optical panel 55. By incorporating the facet 52, one reduces the number density, i.e. the number per unit length, of relatively acute angles cut in the metal master for replication of the microstructure. Indeed the presence of facet 52 over a large fraction of the film surface, facet 52 being substantially coplanar with the film, means that over the corresponding fraction of the master tool little or no cutting is required, thereby reducing cutting element wear.

In optical film manufacturing processes involving the cutting of formations into a tool, such as a drum for the UV curing process described in U.S. Pat. No. 5,175,030, or a slot die for an injection moulding process, the cutting of obtuse angles promotes tolerance with regard to cutting element wear. There is consequently a reduction in the required frequency of cutting element change, due to the greater tolerance of structures with larger internal angles with respect to cutting element wear. Adverse cutting element wear is a very detrimental factor when it comes to the uniformity attainable over the optical panel: it causes variation in the angles of the profile obtained locally across the metal master tool, as well as increasing the likelihood of possible non-uniformities which can arise when the cutting element has to be changed because of wear during the cutting of the metal master tool. It should be emphasized that as manufacturing processes are scaled up to produce ever wider optical films, scaling up for example from film widths of a few tens of centimetres to film widths of a few meters, the master tool must be scaled up correspondingly, which raises considerably the prominence of issues associated with the production of high-quality master tools. These issues apply to the production both of single films for non-tiled large screens and of films for smaller screens, because large width film manufacture followed by cutting up the manufactured film into smaller dimension pieces enables cost savings through economy of scale effects.

In the embodiment of FIG. 15, the planar facet 52 comprises at least some absorbing material 61 to enhance the contrast of the display panel. The incorporation of the black material in facet 52 presents a significant advantage over the prior art by removing the necessity for precision alignment of black stripes provided on the front surface of the panel with the prisms comprising facets 50 and 51. Therefore this embodiment combines the advantages of the previous embodiments, of FIGS. 12, 13 and 14, in relation to the improvements in manufacture of the master tool, with the benefit of allowing easy assembly of the whole screen. This screen can then be modularised and easily incorporated into a rear projection system.

It will be appreciated by those skilled in the art that black stripes for improving the contrast of the image perceived by the viewer may be disposed on both sides of the screen, not merely on one side of the screen, for the various embodiments of the invention discussed herein.

The examples given herein are presented to enable those skilled in the art to more clearly understand and practice the invention. The examples should not be considered as limitations upon the scope of the invention, but as merely illustrative. Numerous modifications and alternative embodiments of the invention will be apparent to those skilled in the art in view of the description, and the following claims are intended to cover all such modifications and variations.

1-16. (canceled)

17. An optical panel comprising an optical film for redirecting light incident upon a rear face of the optical film, the optical film comprising:
a front face; and
a rear face having a plurality of substantially periodic light-deflecting elements disposed thereon, each respective element comprising:
a transparent first facet for transmitting light incident thereupon;
an internally reflecting second facet for effecting internal reflection of the transmitted light within the element;
at least one intermediate facet disposed between and adjoining the first and second facets at first and second junctions respectively; and
a further section disposed between the second facet of the element and a first facet of an adjacent element,
wherein a first full internal angle within the element at the first junction and a second full internal angle within the element at the second junction are at least 90 degrees and less than 180 degrees.

18. The optical panel of claim 17, wherein the at least one intermediate facet comprises a single facet adjoining the first facet at a first junction and adjoining the second facet at a second junction.

19. The optical panel of claim 17, wherein the further section of the element does not have a transmissive or reflective optical function.

20. The optical panel of claim 17, wherein the second facet is arranged to effect internal reflection of the transmitted light by total internal reflection.

21. The optical panel of claim 17, wherein the first facet is a convexly curved focusing element.

22. The optical panel of claim 17, further comprising black stripes disposed on at least one face of the optical panel without substantially blocking a path of the light through the panel.

23. The optical panel of claim 17, wherein the optical film is adapted to receive and redirect light incident thereupon at an angle of incidence with respect to the rear face generally of the film of 45 degrees or greater.

24. A rear projection video system, comprising:
the optical panel of claim 17; and
a projector arranged to project a video image onto the rear face of the optical panel for providing a viewable image downstream of the front face of the optical panel.

25. The optical panel of claim 24, wherein the projector is arranged to project light in a first direction so as to be incident upon the first facet and the at least one intermediate facet is substantially parallel to the first direction.

26. The optical panel of claim 24, wherein the projector is arranged to project light in a first direction so as to be incident upon the first facet, and a region of the first facet closest to the first junction with the intermediate facet is arranged to transmit the incident light in a second direction, and the at least one intermediate facet is substantially parallel to a direction in a range between the first direction and the second direction.

27. An optical film for an optical panel, the optical film having the features of the optical film recited in claim 17.

28. An optical panel for displaying projected light incident upon the optical panel, the optical panel comprising a front face and a rear face, the rear face having a plurality of substantially periodic light-deflecting elements disposed thereon, each respective element comprising:
a transparent first facet for transmitting light incident thereupon;
an internally reflecting second facet for effecting internal reflection of the transmitted light within the element, the second facet being adjoined to the first facet; and
a further section disposed between the second facet of the element and a first facet of an adjacent element, wherein at least one of the first and second facets of the element is convexly curved so that a function of the first and second facets acting in concert includes bringing the transmitted and reflected light to a focus at or near to a plane defined by the front face of the panel, the optical panel further comprising black stripes disposed on at least one face of the optical panel without substantially blocking a path of the light through the panel.

29. A rear projection video system, comprising:
the optical panel of claim 28; and
a projector arranged to project a video image onto the rear face of the optical panel for providing a viewable image downstream of the front face of the optical panel.
